(19) United States
(12) Patent Application Publication
(10) Pub. No.: US 2011/0202521 A1
(43) Pub. Date: Aug. 18, 2011

(54) Enhanced database search features and methods

(76) Inventor: Jason Coleman, Plano, TX (US)

(21) Appl. No.: 12/931,298

(22) Filed: Jan. 28, 2011

Related U.S. Application Data
(60) Provisional application No. 61/336,790, filed on Jan. 28, 2010.

(51) Int. Cl. G06F 17/30

(52) U.S. Cl. 707/709; 707/E17.108

(57) ABSTRACT

The invention teaches systems, methods and devices for searching data storage systems and devices. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CLAIM OF PRIORITY

This Application claims priority to U.S. Provisional Patent Application No. 61/336,790 to common inventor Coleman, dated 28 Jan. 2010 and entitled ENHANCED DATABASE SEARCH FEATURES AND METHODS.

### FIELD OF THE INVENTION

The present invention relates to searching databases, and particularly the Internet.

### Problem Statement

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

In the late 1990's through early 2000's the internet experienced an explosion of searches from users of all backgrounds. Typically, search engines, search internet pages that have been indexed, typically at a price to those who wish to have their pages indexed, and then score that indexed page based on the types of words bound, frequency of words bound, or other methods known in the art. Then, search results are displayed for the user typically in an order considered most relevant to that user. However, internet search engines such as Google® have more recently begun displaying pages using a formula that includes both information sought by the user along with scoring “bonus points” or other scoring features which are purchased most typically by advertisers.

For example, a person searching for a metro transit map of Athens, Greece may enter words into a search engine line such as “Athens Greece Metro”. One might expect such a search to produce maps of the metro of Athens, Greece. However, more commonly such a search will result in the luminous pages of search results that are no more than advertisements from travel agencies. Accordingly, a user is besieged with an inundation of information that is practically useless to that user. Perhaps, after considerable searching deep into the search results (which may exceed millions of results), that user may indeed find a map of the Athens, Greece underground metro. More commonly, however, the user will leave a website frustrated that the desired search information was not found. In addition, the user is frustrated at both the search engine, as well as the providers of the information which he or she views more or less as information noise.

Accordingly, search engines such as Yahoo®, Google®, Ask Jeeves®, A9®, Microsoft®, and the like would benefit from systems, methods, and devices that enable a user to access the information they are genuinely searching for. The present invention provides such systems, methods, and devices.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 illustrates one example of how taxonomy works.

FIG. 2 illustrates dynamic taxonomy according to the invention.

FIG. 3 is a second illustration of dynamic taxonomy according to the invention.

FIG. 4 illustrates dynamic taxonomy in conjunction with segment modeling.

FIG. 5 shows how general taxonomy works in search.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are is provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise. As will be understood by those of ordinary skill in the art, various structures and devices are depicted in block diagram form in order to avoid unnecessarily obscuring the invention.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

Some methods of the invention may be practiced by placing the invention on a computer-readable medium, particularly the control and detection/feedback methodologies. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to operate the methods of the invention. It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

### DETAILED DESCRIPTION OF THE DRAWINGS

### I. Dynamic Taxonomy and Segment Modeling

### Dynamic Taxonomy Origins

The context of the term dynamic taxonomy is Internet search. The use of taxonomy is commonly applicable in search engines and related applications. The term “dynamic taxonomy” as used is not an equivalent term to “taxonomy” as used in the general search industry. Rather, the term is intended to indicate some aspect of its ancestry (taxonomy) and at least one distinctive aspect (dynamic).

### Formal Ontology

It would perhaps be more accurate to call the concept an ontology—more accurately, the concept is a Formal Ontology. It conforms to Formal Ontologies in that:
It is indefinitely expandable—new Specific Domain Ontologies may be added at any level beneath the Upper Ontology.
Content and context independence—in the invention other components are utilized to manage context (Segment Modeling) and content (Terms)
It can accommodate different levels of granularity (see below)
It is reliant upon an Upper Ontology (see below)

### Regarding the Upper Ontology and the Axiom

As a Formal Ontology the concept operates within the bounds of a specific Upper Ontology—which has a fixed framework (or fixed universe—in that it is the sum of all high level categories of content contained on the Internet [or other distributed network]). But its individual components are not strictly fixed. The Upper Ontology is comprised of all the domains of category contained in the Internet (or similar distributed network). The domains that make up the Upper Ontology are not intended to subscribe to any particular defined system—but could be adapted to do so.

The axioms that drive our Formal Ontology are (using informal notation):
{(all D)} A OR {ΣD} A
The set of all possible domain categories is a subset of (or equals) all content on the network.
{(any collection of D)} A
Any collection of possible domain categories is a subset of all content on the network.
{(D)} A
Any possible domain category is a subset of all content on the network. Where . . . D=any possible domain category(entity) A=All content on the network (One implementation could be: {“News”, “Blogs”, “Images”, “Video”, “Shopping”}=A)

### Manifold Novel Specific Domain Ontology Matrix

One fully accurate term that may work in place of “Dynamic Taxonomy” may be “Manifold Novel Specific Domain Ontology Matrix”—unfortunately unwieldy. But this term should be understood in the context that it is used for the purposes of framing our concept within highly specific existing language.

One embodiment of our concept could be described as follows: A system of Specific Domain Ontologies—one for each Upper Ontology category domain (entity). One or more Specific Domain Ontologies may exist within each entity. These entities may overlap or even be duplicative of one another—but each one is a distinct ontology related to a specific domain. Some of these will be created, maintained and “owned” by the search engine provider—and thus be public in that they are available to all users of the system. Others will be created, maintained and “owned” by individuals or groups [see themes]. Some may replicate Specific Domain Ontologies that have origins elsewhere—and within their own four corners maintain different ontological rules. Some will be Novel and unique to this system. Some may be replicative or derivative of other specific domain ontologies—even others within this system. The groups or individuals that “own” each domain specific ontology will control access (public or private) to their entity via the membership engine of the system.

Alternate terms that may be of more use in future applications include, for example:
Manifold Ontology Schema
Dynamic Ontology Matrix Schema
Manifold Novel Specific Domain Ontology Matrix

### Dynamic Taxonomy and Segment Modeling

Those aspects of “Dynamic Taxonomy” specifically as it relates to its usage in the search engine and interface designs are unique. Internet search suffers from the disadvantages of interface and interactivity, and is a large and complex problem, but boiled down it can be described as a steadily increasing problem of scale. As more and more information goes online and more and more content owners compete to get at the top of the results stack, it becomes increasingly difficult for search engines to accurately determine results relevancy.

One of the best ways to understand this problem is to do so in terms of the concept of the meme. Memes are part of an abstract theory of human knowledge in which a meme is generally defined as a single unit of cultural information. While there is a lot of valid criticism of the concept of memes, it can be illustrative to think about the types of things people search for on the Internet as memes.

In other words, even with the kind of powerful algorithms at society's disposal thanks to the likes of Google®, society faces an information glut of epic proportions. This problem is illustrated by the seemingly infinite number of pages one sees at the bottom of the screen when you make most any common search on Google. And as any person who uses a major search engine can tell—after the first few pages the results can start becoming irrelevant very quickly. An important challenge that comes out of this problem is to develop a method of better understanding the kind of content (content type, content category and type of desired relationship) a user is searching for. Even with powerful algorithms, this is a persistent problem.

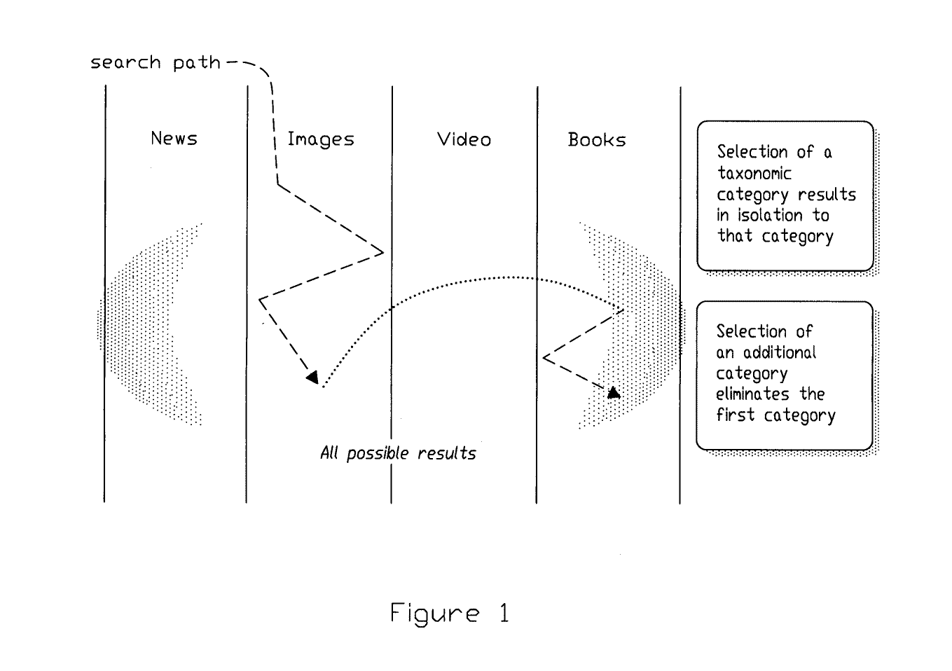

Taxonomies are one kind of traditional solution. Taxonomic solutions are one valid kind of solution to this problem, but they too, have their limitations. For example, one cannot search both the ‘News’ search type category and the ‘Image’ search type category of any prior art engine at the same time. As illustrated in FIG. 1, below, taxonomic solutions as they are implemented on the web now are strictly linear and categorically exclusive. The interface provides no way to search the intersection of the News and Images search categories. The user can only search in one category at a time. Even using Google's advanced search features can't help.

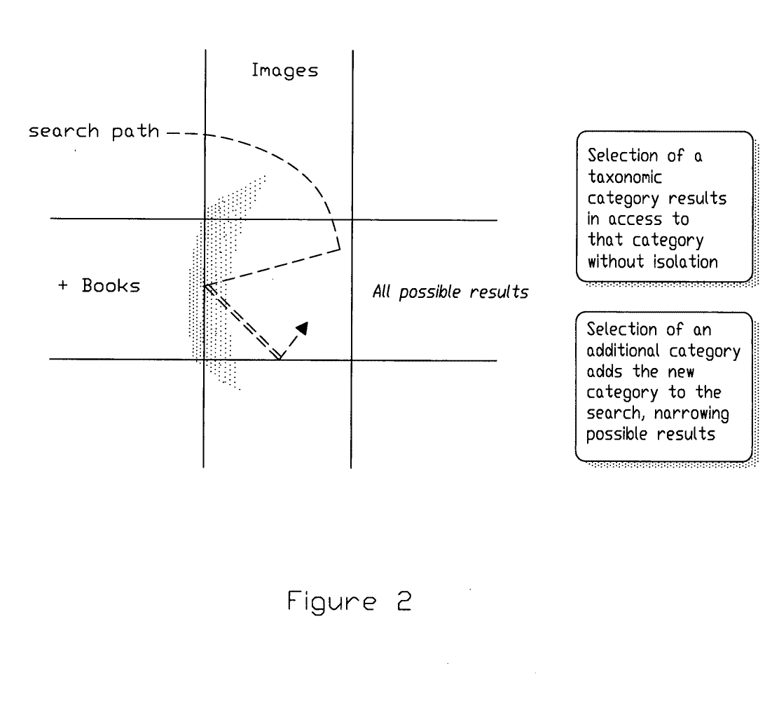

The concept of Dynamic Taxonomy was created as a direct response to this limitation. When one gives users the ability to select one or more taxonomic categories at once, it enables the search engine to identify the meta intent of the user with much greater precision. The search engine starts getting a factoring effect in narrowing down the possible results. FIG. 2 shows how this differs from the previous abstraction of prior art taxonomies. It is important to note that this solution enables the user to make and use this meta distinction before, during or after results are generated, even without understanding exactly what is going on. (Another possible solution here, would be to use natural language algorithms to derive the meta intent of the user—this method could be integrated with a natural language approach at the point that terms are entered.)

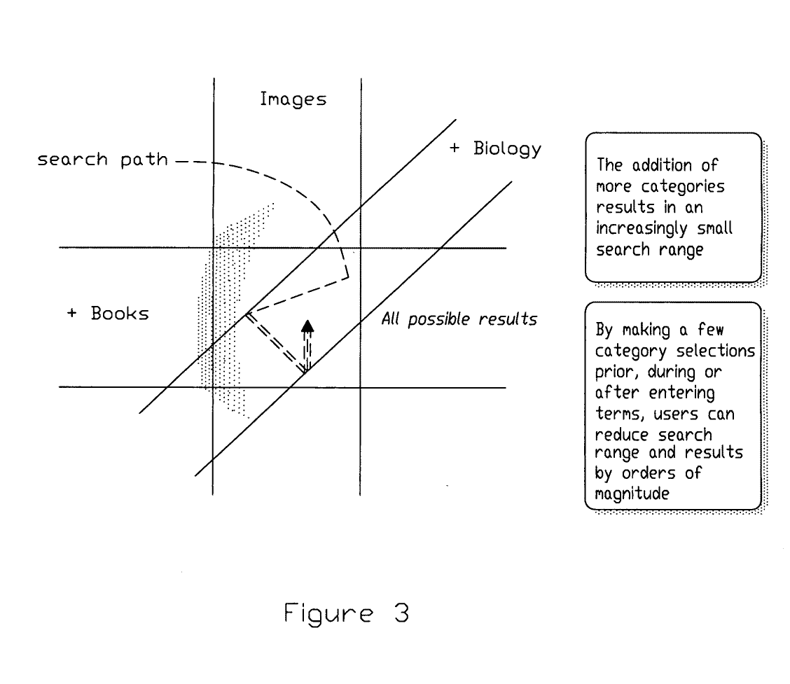

The addition of a third domain category (or entity) is illustrated in FIG. 3. Unlike what happens in prior art search engines that employ traditional taxonomy in any form, the addition of more taxonomic categories to the search does not eliminate other taxonomic categories. The user can search an increasingly narrower range of possible results, thereby increasing accuracy and relevancy of results, and greatly increasing the speed and efficiency of search attempts.

It should now be clear that Dynamic Taxonomy is a distinct concept from taxonomy. It could be seen as an extension of and enhancement to the concept of taxonomy as used on the web now and in 2005, but it introduces new and original concepts that are not used now and were not then.

Segment Modeling is another aspect of the inventive solution that extends Dynamic Taxonomy and further enhances the ability of users to perform precise searches. Segment Modeling, like Dynamic. Taxonomy is based on taxonomy (and is perhaps better defined as an ontology), except rather than containing entities that are focused on defining the nature and/or type of content it's entities describe the kinds of behaviors user used to engage with or expected out of the content. You could also think of this as the kind of ‘relationship’ the user wants or expects to have with the content. Examples of Segments might be:
Shopping (commercial)
Reference material
Non-commercial
Business to Business
Person to Person
Business to Person
Person to Business

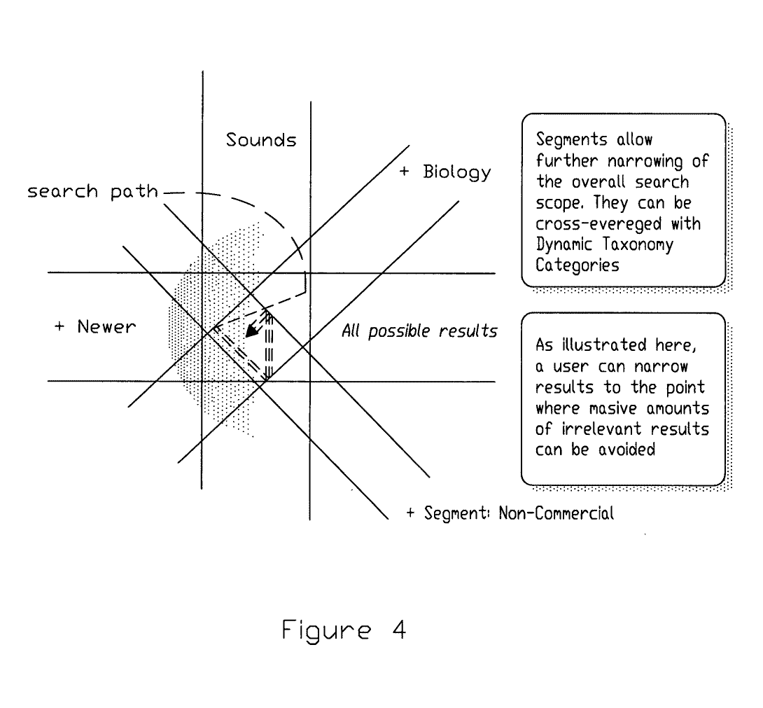

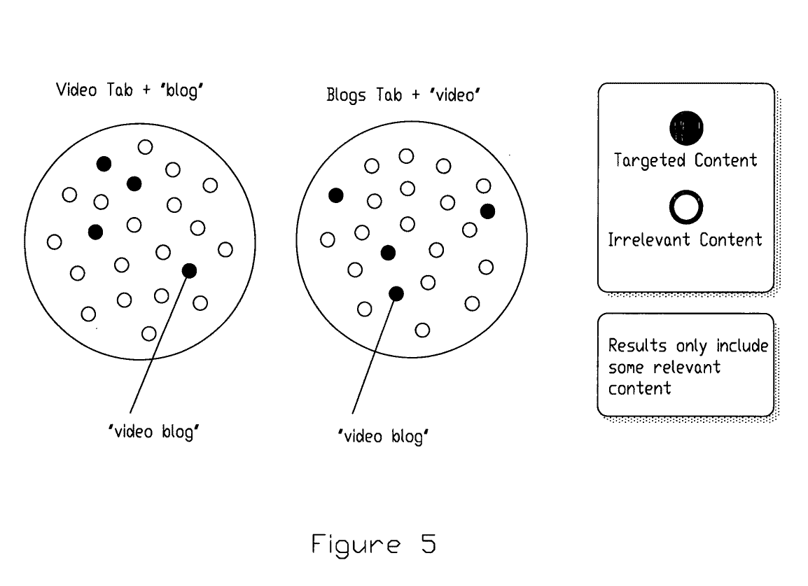

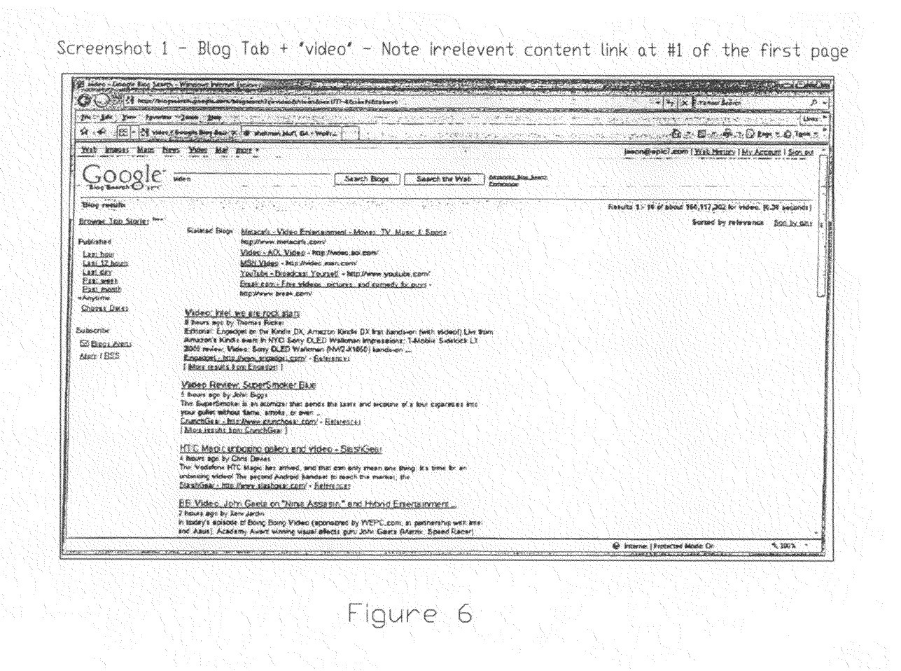

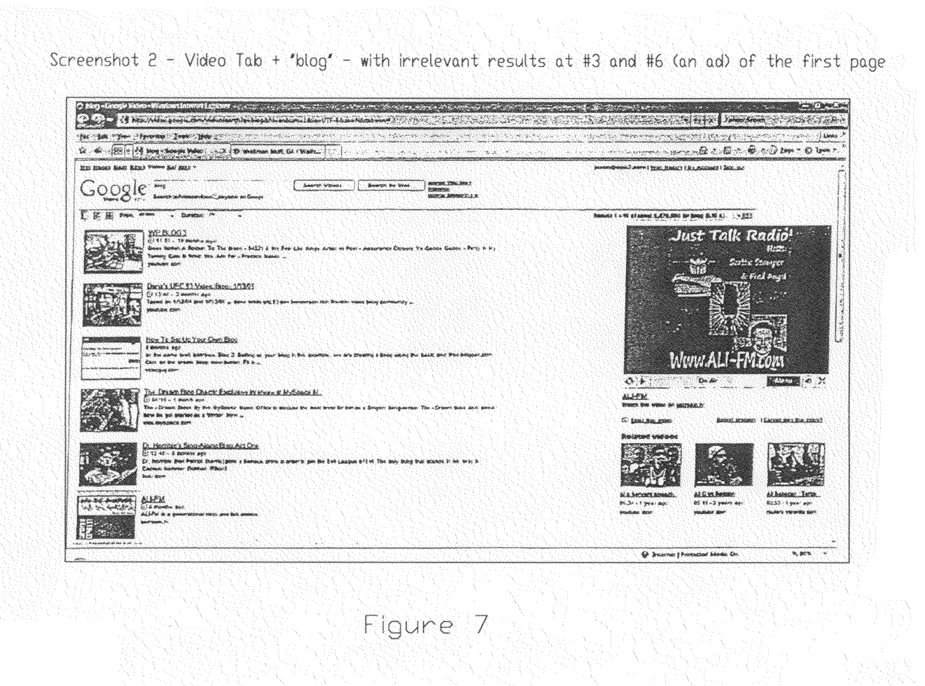

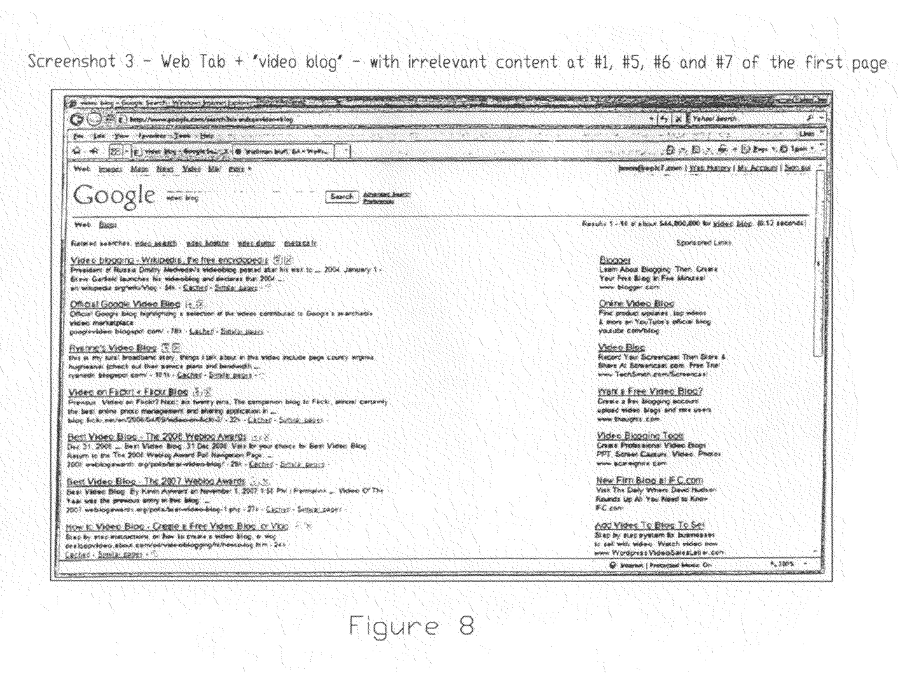

Segment Modeling provides yet another method for users to narrow down the possible results before, while or after entering search terms. FIG. 4 illustrates the addition of a Segment to a search.

Another manner of usage that differentiates Dynamic Taxonomy from taxonomy as used in search. This differentiator is the fact that, unlike the broad and fixed categorization that characterizes taxonomy as used by other search engines and Biological (or Alpha Taxonomy), the present invention's Dynamic Taxonomy is a variegated set of categories—each of which evolves alongside the folksonomy of that category over time—dynamically as the words and categories of the users who search that content change.

Compare this to the way, for example, that taxonomy is used at Google®—taxonomic categories are exceedingly broad—they include “Web”, “Images”, “News”, “Video”, “Books”, “Real Estate” and similarly expansive categories. Within each of these categories the user has no ability to further divide their search range into more defined subcategories. Further, these categories are very rigid, and change over time only as configured by staffers at Google.

An inspection of Ask reveals the same kind of usage of taxonomy. And, although taxonomies may change over time (sometimes referred to as a thesaurus effect), and thesauri do change over time—the change tends to be slow and is certainly not anything that would be referred to as “dynamic.” Therefore, even more sophisticated models of taxonomy usage in the industry are based on rigid, non-dynamic models.

Accordingly, the present invention is distinguished from prior implementations of taxonomy by, among other things:
Variability in structure
Possible duplication of entities in the same domain
Changes dynamically over time
Does not require staffer implementations to change—that is, Novel Domain Specific Ontologies may be created and maintained by individual users
Specialized within broad categories
Interfaces with Segment Modeling and multi-category selection searches

### II. Dynamic Taxonomy is Not Categorically Exclusive

### Categorical Exclusion

Traditional taxonomy usage in the search industry, is for the most part like Alpha Taxonomy (the original unambiguous term that referred to describing and classifying organisms—as used in Biology). There are some minor exceptions to this that blur the edges somewhat, but by and large, a loosely rigid traditional taxonomic system is what is utilized by search engines of all varieties.

For the purpose of this discussion we will utilize a hypothetical search. A search user is seeking blogs (web logs) that are in video format (not blogs that include video or are about video—but video blogs). To illustrate the current state of the industry solution, we will utilize the Google® interface and search engine. There are presently three ways one could embark on this search in Google®:
Enter the terms “video blog” in the Google® search field (i.e. Web search/general search)
Click on the “Video” link to select the Video search and enter “blog” in the Google® search field
Click on the “more” option and choose “Blogs” from the pull-down, then enter “video” in the Google® search field
   Each of these searches, suffers from an impairment—an inability to measure user intent. This can be demonstrated by looking at the results. Within each result set the user finds some of what they are looking for—but he also finds other things that do not match his intent—and these non-matching results begin occurring on the first page of results—in as high a position as 1st. Screenshots 1-3 demonstrate the results—which aren't horrible (the impact is only moderate with just two factors)—but they are not entirely accurate either. Where:
   Screenshot 1—Blog Tab+“video”—Note irrelevant content link at #1 of the first page
   Screenshot 2—Video Tab+“blog”—with irrelevant results at #3 and #6 (an ad) of the first page
   Screenshot 3—Web Tab+“video blog”—with irrelevant content at #1, #5, #6 and #7 of the first page
   In each of these cases, the fundamental problem is the same—the failure to measure user intent can clearly be seen. FIG. 1 shows an abstraction of how relevant results are mixed with irrelevant results.

In other words, the Google® interface understands that the user is looking for “blog” within the video category (in one case), that the user is looking for “video” within the blog category (in another) and that the user is looking for “video” and “blog” (in the other)—but in no case does the Google® interface understand that the user is looking for “blogs with video.” Even if we type in “blogs with video”—the user gets irrelevant results (in screenshot 4).

Screenshot 4—“blogs with video”—with irrelevant results at #3, #4 and #6 of the first page.

To accurately capture this kind of user intent with the Google® (and other good search engines) interface as it exists now, Google® would have to add a new Tab category—“Video Blogs.” To further illustrate this example, go one step further—a hypothetical search for “video news blogs.” Again, there is an ambiguity here—does the user mean that they are looking for news blogs that contain video, or video blogs about news, or news about video blogs, or news video about blogs? Accordingly, the more terms are involved, the greater the potential ambiguity, and the greater the potential difficulties in determining and/or measuring the user's intent. The number of possible permutations increases dramatically, depending on the number of terms and categories.

The interface design framework of the invention enables an embodiment of this system to fully distinguish each of these possible permutations, by breaking out terms from meta-intent and relationship-intent. By differentiating these different aspects of the user's intent (see below) and applying that intent across Dynamic Taxonomy, Segment Modeling and other aspects of Themes, our invention achieves significant advantages in producing relevant results.

III. Measuring User Intent with Dynamic Taxonomy, Segment Modeling & Terms

### User Intent

One of the more challenging aspects of search engine implementation is the task of understanding user intent. The typical search engine solution is dependent upon identifying and extracting a set of words that the user is searching for. These are generally described as the “terms” of the search. Terms may be simply words typed into a field, or they may be further qualified, using techniques such as natural language algorithms.

An example of user term entry: “Video blog news” & the resulting terms:
{“video”, “news”, “blog”}
An example of a natural language user entry: “Video, blog and news” & the resulting terms: {“video”, “news”, “blog”}

A given set of words (terms) field the resulting possible interpretations may impair finding accurate results because measuring user intent is either challenging or impossible. One implementation of our invention would enable the search engine to measure the intent of the user of a search engine in the following novel manner. User interaction and term input with our interface provides a simple method for clearly identifying at least three kinds of intent:
meta-intent
relationship-intent
content-intent

Meta-intent is the expression of the desired attributes of the targeted material, outside of its content. Users can access multiple hierarchies of multiple entities, both private and public to use to define this form of intent. This can include, but is not limited to, the following:
general (none)
age of content (e.g.: younger, older, date-range)
geography
source material (e.g.: book, magazine, online, tv, radio, cinema)
source entity (e.g.: government, ngo, private, commercial, major media outlet, personal)
media (e.g.: video, audio, image, text, pdf, html, flash, mixed)
format (e.g.: blog, mashup, portal, interactive, experimental)
knowledge domain (e.g. biology, physics, psychology, fine arts)

Relationship-intent is the expression of the relationship the user desire with the targeted material, outside of its content or meta-data. Users can access multiple hierarchies of multiple entities, both private and public to use to define this form of intent. This can include, but is not limited to, the following:
general (none)
reference
shopping
real estate
business info
people info
statistics
public records
geographic info
   IV. Enabling and Controlling Publisher Intent with Dynamic Taxonomy, Segment Modeling & Terms

### Publisher Intent

### Morphological Characteristic Search:

Predominant color

### Flash/no Flash

Domain root only
Secondary/tertiary folder limit

### AV Search Capabilities

Audio/word search capability
Video/word search capability

### Statistical Results Table

Breakdown by each term/condition
Show % out of all possible results
Show distribution across results
Graphs
   Contextual Splines—Used to indicate points of contextual, thematic, or attributive commonality between n items or n sets of content.
Enhancement to cloud type result sets in that it illustrates the specific natures of the relationships of items in the cloud.
Can help to illustrate means to further refine search. Can help illustrate redundancies in search.
Can help to illustrate meaning and provide depth of insight into results.
N number of splines can be applied across any result set.
Individual spline types can be toggled off or on to illustrate different relationships.
May be applied to search terms and conditions as well as results
   Internet Publisher Authentication—This process solves a problem that arises out of the requirements of many of the other inventions in regards to establishing and relying on content publisher accounts to self-describe content. It enables an operator of a search engine to reliably authenticate a content publisher without relying on a third party. This invention could be structured in a way so that it is an extension of existing applications or it could be structured as a new invention.

### Variable Dimensional Search Refinement

This extends the existing “Dynamic Taxonomy” and Manifold Novel Specific Domain Ontology (or Variable Manifold Domain Ontology). It is a way to model or construct metaphorical meaning or provide graphical illustration of search terms and conditions as well as results.

This is a concept of locating content as though the desired content were n dimensional coordinates. The specificity of the desired content increases as more coordinates are known, just as the specificity of a location increases as the number of coordinates is known.

### Variable Hierarchy of Content Descriptor Relevance

This is a process by which:
The user of a search interface can express the desired method of relevance model to use
The creator of a search interface (theme vertical) can express the default or standard method of relevance determination
The method of relevance determination can be utilized by a search results generator
The data components that must be collected or derived form content to map relevance to
   This process includes the following major attributes:
Audience (public/consumer/non-expert/crowd-source)
Content publisher (self-described—by meta or direct account control)
Algorithm determined assignment
Expert assignment
Special Audience (quasi experts/enthusiasts/vertical theme members)

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A method of generating a result for an Internet search engine, comprising:
using crawler data to create a first variable score;
using interne publisher data to create a second variable score;
using user generated data to create a third variable score;
using editorial data to create a fourth variable score; and
generating a search score based on the search terms the user chose to search for, as a function of the first variable score, the second variable score, the third variable score and the fourth variable score.
